(19) United States
(12) Patent Application Publication
(10) Pub. No.: US 2018/0032608 A1
(43) Pub. Date: Feb. 1, 2018

(54) FLEXIBLE SUMMARIZATION OF TEXTUAL CONTENT

(71) Applicant: LinkedIn Corporation, Mountain View, CA (US)

(72) Inventors: Bin Wu, Palo Alto, CA (US); Weiqin Ma, San Jose, CA (US); Wenxuan Gao, Santa Clara, CA (US); Weidong Zhang, San Jose, CA (US)

(73) Assignee: LinkedIn Corporation, Mountain View, CA (US)

(21) Appl. No.: 15/221,367

(22) Filed: Jul. 27, 2016

(51) Int. Cl. G06F 17/30; G06F 17/22

(52) U.S. Cl. CPC G06F 17/30719; G06F 17/30616; G06F 17/30693; G06F 17/2211

(57) ABSTRACT

The disclosed embodiments provide a system for processing textual content. During operation, the system obtains a content item containing a set of text units. For each text unit in the set of text units, the system obtains a similarity score representing a similarity of the text unit to other text units in the content item and calculates a ranking score for the text unit from a combination comprising a text unit frequency for the text unit, the similarity score, and a position weight associated with a position of the text unit in the content item. The system then ranks the set of text units by the ranking score and uses the ranking to display a summary containing a subset of the text units in the content item.

### BACKGROUND

### Field

The disclosed embodiments relate to text analytics. More specifically, the disclosed embodiments relate to techniques for performing flexible summarization of textual content.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, data analytics may be used to assess past performance, guide business or technology planning, and/or identify actions that may improve future performance.

In particular, text analytics may be used to model and structure text to derive relevant and/or meaningful information from the text. For example, text analytics techniques may be used to perform tasks such as categorizing text, identifying topics or sentiments in the text, determining the relevance of the text to one or more topics, assessing the readability of the text, and/or identifying the language in which the text is written. In turn, text analytics may be used to mine insights from large document collections, which may improve understanding of content in the document collections and reduce overhead associated with manual analysis or review of the document collections.

### BRIEF DESCRIPTION OF THE FIGURES

FIG. 1 shows a schematic of a system in accordance with the disclosed embodiments.

FIG. 2 shows a system for processing textual content in accordance with the disclosed embodiments.

FIG. 3 shows a flowchart illustrating the processing of textual content in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

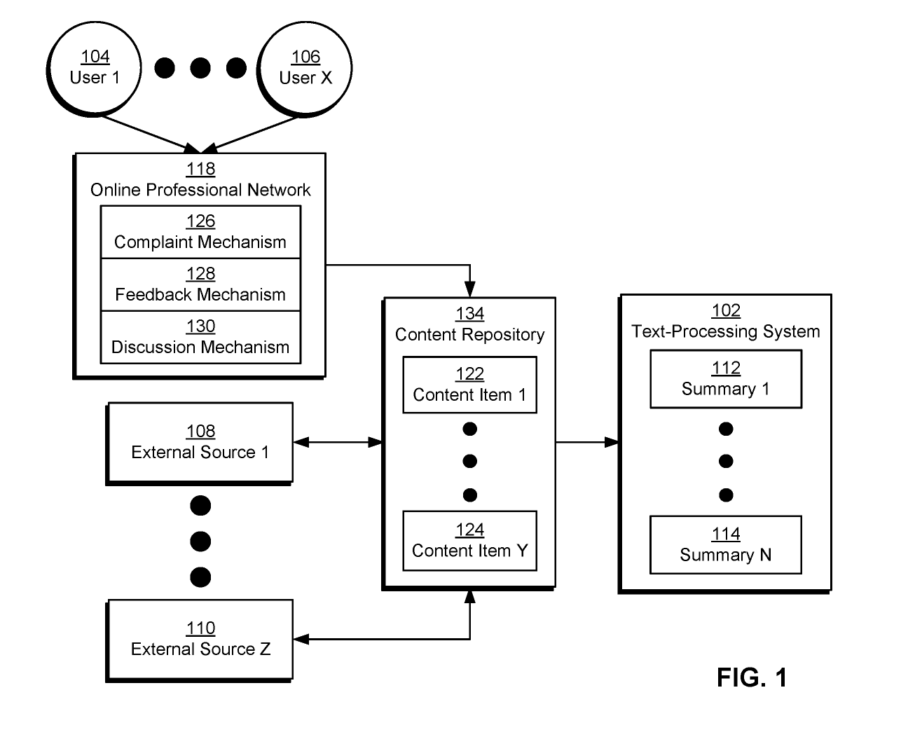

The disclosed embodiments provide a method, apparatus, and system for processing data. More specifically, the disclosed embodiments provide a method, apparatus, and system for performing flexible summarization of textual content. As shown in FIG. 1, the textual content may include a set of content items (e.g., content item 1 122, content item y 124). The content items may be obtained from a set of users (e.g., user 1 104, user x 106) of an online professional network 118 or another application or service. The online professional network may allow the users to establish and maintain professional connections, list work and community experience, endorse and/or recommend one another, and/or search and apply for jobs. Employers and recruiters may use the online professional network to list jobs, search for potential candidates, and/or provide business-related updates to users.

As a result, content items associated with online professional network 118 may include posts, updates, comments, sponsored content, articles, and/or other types of unstructured data transmitted or shared within the online professional network. The content items may additionally include complaints provided through a complaint mechanism 126, feedback provided through a feedback mechanism 128, and/or group discussions provided through a discussion mechanism 130 of online professional network 118. For example, the complaint mechanism may allow users to file complaints or issues associated with use of the online professional network. Similarly, the feedback mechanism may allow the users to provide scores representing the users' likelihood of recommending the online professional network to other users, as well as feedback related to the scores and/or suggestions for improvement. Finally, the discussion mechanism may obtain updates, discussions, and/or posts related to group activity on the online professional network from the users.

Content items containing unstructured data related to use of online professional network 118 may also be obtained from a number of external sources (e.g., external source 1 108, external source z 110). For example, user feedback for the online professional network may be obtained periodically (e.g., daily) and/or in real-time from reviews posted to review websites, third-party surveys, other social media websites or applications, and/or external forums. Content items from both the online professional network and the external sources may be stored in a content repository 134 for subsequent retrieval and use. For example, each content item may be stored in a database, data warehouse, cloud storage, and/or other data-storage mechanism providing the content repository.

In one or more embodiments, content items in content repository 134 include text input from users and/or text that is extracted from other types of data. As mentioned above, the content items may include posts, updates, comments, sponsored content, articles, and/or other text-based user opinions or feedback for a product such as online professional network 118. Alternatively, the user opinions or feedback may be provided in images, audio, video, and/or other non-text-based content items. A speech-recognition technique, optical character recognition (OCR) technique, and/or other technique for extracting text from other types of data may be used to convert such types of content items into a text-based format before or after the content items are stored in content repository 134.

Because content items in content repository 134 represent user opinions, issues, and/or sentiments related to online professional network 118, information in the content items may be important to improving user experiences with the online professional network and/or resolving user issues with the online professional network. For example, a text-processing system 102 may be used to perform text-analytics queries that apply filters to the content items; search for the content items by keywords, blacklisted words, and/or whitelisted words; identify common or trending topics or sentiments in the content items; perform classification of the content items; and/or surface insights related to analysis of the content items.

However, content repository 134 may contain a large amount of freeform, unstructured data, which may preclude efficient and/or effective manual review of the data by developers and/or designers of online professional network 118. For example, the content repository may contain millions of content items, which may be impossible to read in a timely or practical manner by a significantly smaller number of developers and/or designers. In addition, longer-form content such as articles and reviews may have a large amount of text, which may occupy significant space in a graphical user interface (GUI) associated with text-processing system 102 and/or require a significant amount of time to read and/or understand.

In one or more embodiments, text-processing system 102 improves analysis and understanding of longer-form content items in content repository 134 by generating and displaying summaries (e.g., summary 1 112, summary n 114) of the content items. For example, the text-processing system may extract a subset of words, phrases, sentences, and/or other text units from the content items into summaries of the content items. As described in further detail below, the text-processing system may combine frequencies, similarity scores, and position weights of text units in a content item into ranking scores for the text units. The text-processing system may then rank the text units by the ranking scores and display a subset of the text units with ranking scores that exceed a tunable threshold in the summaries. Consequently, the text-processing system may perform flexible, efficient generation of summaries for content items independently of the genres, sources, formats, and/or languages of the content items.

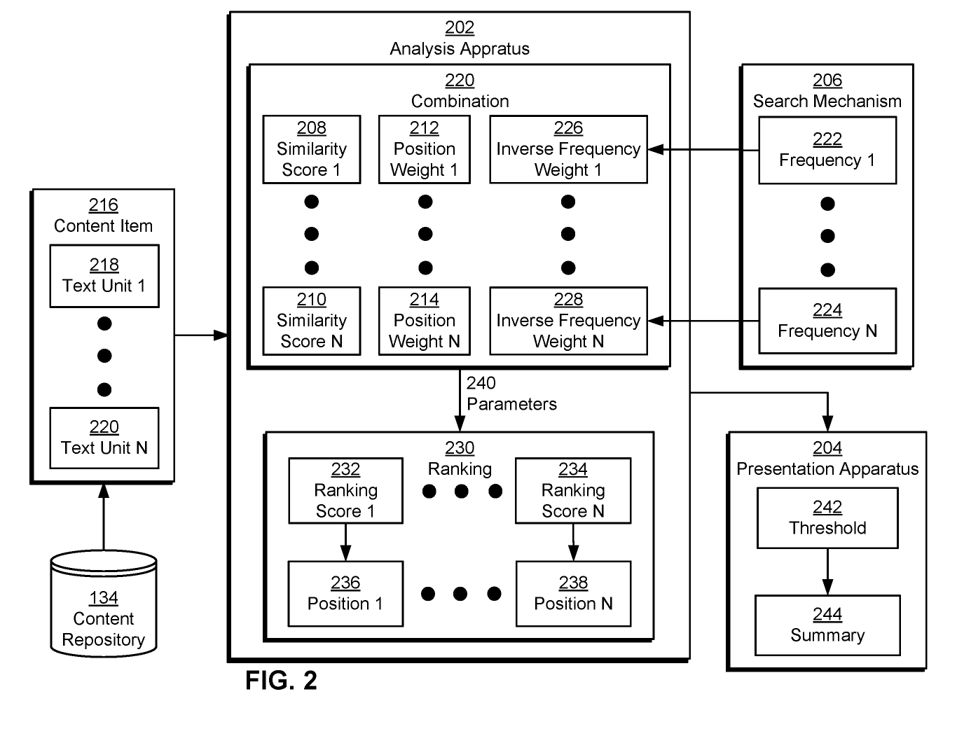

FIG. 2 shows a system for processing textual content, such as text-processing system 102 of FIG. 1, in accordance with the disclosed embodiments. The system of FIG. 2 includes an analysis apparatus 202 and a presentation apparatus 204. Each of these components is described in further detail below.

Analysis apparatus 202 may obtain a content item 216 from content repository 134 and separate the content item into words, n-grams, phrases, clauses, sentences, and/or other text units (e.g., text unit 1 218, text unit n 220). During generation of the text units, the analysis apparatus may optionally correct for misspellings in the text units, account for spelling variations across different forms or dialects of a language, perform stemming of the words, remove stop words from the text units, and/or otherwise transform text in the text units into a normalized form.

Next, analysis apparatus 202 may obtain and/or calculate a set of numeric values associated with the text units. As shown in FIG. 2, the values may include a set of similarity scores (e.g., similarity score 1 208, similarity score n 210), a set of position weights (e.g., position weight 1 212, position weight n 214), and a set of inverse frequency weights (e.g., inverse frequency weight 1 226, inverse frequency weight n 228).

First, analysis apparatus 202 may calculate the similarity scores by matching words in each text unit to words in other text units in content item 216. For example, the analysis apparatus may use natural language processing (NLP) techniques to calculate the similarity score for each text unit based on the similarity and/or overlap of words and/or n-grams in the text unit with other words and/or n-grams in the content item, excluding the text unit. The similarity and/or overlap may be based on exact matches of the words and/or n-grams and/or matching of synonyms in the words and/or n-grams to one another. After the similarity and/or overlap are determined, the similarity score may be produced as a “soft” cosine similarity, Jaccard similarity, Dice coefficient, and/or other measure of similarity between the text unit and the remainder of the content item. As a result, the similarity score may measure the degree to which the text unit represents or reflects the content in the content item.

Second, analysis apparatus 202 may obtain a set of frequencies (e.g., frequency 1 222, frequency n 224) of the text units from a search mechanism 206 and use the frequencies to calculate the inverse frequency weights for the text units. For example, the analysis apparatus may input each text unit as a search term in a query to a search engine and obtain the frequency of the text unit as the number of search results returned in response to the query. Alternatively, the analysis apparatus may extract keywords and/or smaller text units from the text unit and use the extracted text as one or more search terms that are used to establish the frequency of the text unit.

Analysis apparatus 202 may then calculate the inverse frequency weight of the text unit from the text unit's frequency and a total frequency for the set of text units in content item 216. For example, the inverse frequency weight may be calculated as log(total_frequency/frequency), where “total_frequency” is the sum of all frequencies for all text units in the content item and “frequency” is the frequency of the text unit. In another example, the inverse frequency weight may generally be calculated using any variation on inverse document frequency (idf), such as probabilistic idf, idf smooth, and/or idf max. By measuring the “commonness” or popularity of the text unit, the inverse frequency weight may indicate the amount of valuable information in the text unit, with a higher inverse frequency weight representing less “commonness” and more valuable information in the text unit.

Third, analysis apparatus 202 may assign a position weight to the text unit based on the position of the text unit in content item 216. For example, the analysis apparatus may assign position weights to sentences in the content item according to the positions of the sentences in one or more paragraphs of the content item and the relative importance of sentences in a typical paragraph structure associated with the genre and/or language of the content item. As a result, the first sentence in each paragraph may be given the highest position weight, and sentences following the first sentence may be assigned gradually decreasing position weights until the middle section of the paragraph is reached. Sentences in the middle section of the paragraph share the same low position weight. Sentences near the end of the paragraph may then be assigned higher position weights than sentences in the middle section of the paragraph. Position weights could be obtained from either a predefined table or a formula.

After a similarity score, inverse frequency weight, and position weight are obtained and/or calculated for a text unit, analysis apparatus 202 may use a combination of the similarity score, inverse frequency weight, position weight, and/or one or more parameters 240 to produce a ranking score (e.g., ranking score 1 232, ranking score n 234) for the text unit. For example, the analysis apparatus may calculate the ranking score for the text unit using the following formula:

ranking_score=(α+β*inverse_frequency_wt)*similarity*position_wt

In the above formula, “inverse_frequency_wt” represents the inverse frequency weight, and α and β are parameters that are tuned to the source and/or type of content item 216. For example, a regression technique may be applied to content items with labeled ranking scores to determine different values of α and β for content items from customer surveys, articles, complaints, reviews, group discussions, social media content, and/or other sources.

Consequently, the ranking score may represent a measure of the relative value of the text unit, compared with other text units in content item 216. For example, the inverse frequency weight may associate more value to a less common text unit than to a more common text unit. If multiple text units are substantially equally common, the similarity scores of the text units may differentiate between the relative values of the text units. Finally, the values of the text units may be influenced by the importance associated with the positions of the text units in a paragraph and/or other structure in the content item.

Analysis apparatus 202 may then generate a ranking 230 of the text units by the ranking scores. For example, the analysis apparatus may rank the text units in descending order of ranking score, so that text units with higher ranking scores are higher in the ranking and text units with lower ranking scores are lower in the ranking. The analysis apparatus may also use the ranking to determine a set of positions (e.g., position 1 236, position n 238) of the text units in the ranking and output the positions according to the ordering of the text units in content item 216. For example, the analysis apparatus may store, in an array and/or other type of indexed data structure, a numeric value of 1 to 10 in ten elements representing ten sentences in the content item. Within the data structure, the numeric value stored in a given element may represent the position of the corresponding sentence in the ranking, while the numeric index to the element may represent the position of the sentence in the content item. The data structure may be included as metadata for the content item to facilitate on-the-fly summarization of the content item.

Finally, presentation apparatus 204 may use ranking 230 and a threshold 242 to display a summary 244 containing a subset of the text units in content item 216. In particular, the presentation apparatus may display a subset of the text units with ranking scores that exceed the threshold (i.e., text units with the highest value in the content item) in the summary and omit remaining text units from the summary. The summary may be displayed within a GUI for performing text-analytics, an online professional network (e.g., online professional network 118 of FIG. 1), and/or another source of content. The summary may also, or instead, be delivered via email, a messaging service, a voicemail, and/or another mechanism for communicating or interacting with users.

Presentation apparatus 204 may optionally display representations of the omitted text units in the summary to indicate portions of the original content item that have been removed from the summary. For example, the presentation apparatus may display an ellipsis and/or other symbol representing omitted content between sentences in the summary. A user may click and/or otherwise interact with the concise representation to view some or all of the omitted content.

Moreover, threshold 242 may be selected by presentation apparatus 204 to achieve a certain level of compression of content item 216 in summary 244. For example, the presentation apparatus may generate a summary that is approximately 10% of the size of the content item by selecting a ranking score threshold that omits the lowest-ranked 90% of text units from the summary. Alternatively, the presentation apparatus may achieve the same compression by setting an integer threshold representing 10% of the text units and selecting text units from the ranking for inclusion in the summary until the threshold is reached. The presentation apparatus may additionally provide a user-interface element (e.g., text field, slider, etc.) for adjusting the level of compression and update the displayed summary accordingly.

The operation of analysis apparatus 202 and presentation apparatus 204 may be illustrated using the following exemplary content item:
“Hard to believe, but Steve Jobs has been gone for four years. But he's really not gone. His influence on leadership, technology, innovation and just plain being cool continues. Other effective CEOs have gone onto the big boardroom in the sky in recent years but there is not much talk about them. I don't think Steve wrote any books about leadership or innovation or how to build a great company. The books are written about Steve Jobs, not by him. His speeches were all about Apple products, not how to be an entrepreneur. He was private about his personal life. No big philanthropic monument has been named in his memory. What is the fascination?”
   The content item may be separated into ten sentences followed by the corresponding frequencies, inverse frequency weights, and similarity scores:
1. “Hard to believe, but Steve Jobs has been gone for four years.”: frequency=6,780,000
   inverse frequency weight=2.1082
   similarity score=0.1694
2. “But he's really not gone.”:
   frequency=225,000,000
   inverse frequency weight=0.5872
   similarity score=0.0731
3. “His influence on leadership, technology, innovation and just plain being cool continues.”:
   frequency=63,800,000
   inverse frequency weight=1.1346
   similarity score=0.2356
4. “Other effective CEOs have gone onto the big boardroom in the sky in recent years but there is not much talk about them.”:
   frequency=546,000
   inverse frequency weight=3.2022
   similarity score=0.3059
5. “I don't think Steve wrote any books about leadership or innovation or how to build a great company.”:
   frequency=45,300,000
   inverse frequency weight=1.2833
   similarity score=0.1895
6. “The books are written about Steve Jobs, not by him.”:
   frequency=42,300,000
   inverse frequency weight=1.3131
   similarity score=0.3239
7. “His speeches were all about Apple products, not how to be an entrepreneur.”:
   frequency=1,060,000
   inverse frequency weight=2.9141
   similarity score=0.3765
8. “He was private about his personal life.”:
   frequency=451,000,000
   inverse frequency weight=0.2852
   similarity score=0.2951
9. “No big philanthropic monument has been named in his memory.”:
   frequency=3,290,000
   inverse frequency weight=2.4222
   similarity score=0.3426
10. “What is the fascination?”:
   frequency=30,700,000
   inverse frequency weight=1.4523
   similarity score=0.0703

Position weights may be assigned to the sentences according to the following:

| Sentence Position | Position Weight |
|---|---|
| 1 | 1.0 |
| 2 | 0.9 |
| 3 | 0.8 |
| 4 | 0.5 |
| 5 | 0.5 |
| 6 | 0.5 |
| 7 | 0.5 |
| 8 | 0.5 |
| 9 | 0.6 |
| 10 | 0.7 |

Values of α=0 and β=1 may then be used to produce, in the order that the sentences appear, ranking scores of 0.3561, 0.0386, 0.2138, 0.4898, 0.1216, 0.2127, 0.5486, 0.0421, 0.4979, and 0.0714 for the sentences. The ranking scores may also be used to output the corresponding positions of the sentences in ranking 230 as 4, 10, 5, 3, 7, 6, 1, 9, 2, and 8.

The ranking scores, positions, and/or threshold 242 may then be used to produce the following summary, which is approximately half the size of the content item:
“Hard to believe, but Steve Jobs has been gone for four years. ( . . . ) Other effective CEOs have gone onto the big boardroom in the sky in recent years but there is not much talk about them. ( . . . ) His speeches were all about Apple products, not how to be an entrepreneur. ( . . . ) No big philanthropic monument has been named in his memory. ( . . . )”
   The summary includes the first, fourth, seventh, and ninth sentences in the content item, in their original order. Within the summary, omitted sentences are denoted with ellipses in parentheses, which can be clicked and/or otherwise expanded to reveal the omitted text.

To further compress the content item, a more stringent threshold 242 may be applied to the sentences. For example, the content item may be compressed to 20% of original size in the following summary, which contains only the seventh and ninth sentences in the content item:
“( . . . ) His speeches were all about Apple products, not how to be an entrepreneur. ( . . . ) No big philanthropic monument has been named in his memory. ( . . . )”

Those skilled in the art will appreciate that the system of FIG. 2 may be implemented in a variety of ways. First, analysis apparatus 202, presentation apparatus 204, and/or content repository 134 may be provided by a single physical machine, multiple computer systems, one or more virtual machines, a grid, one or more databases, one or more filesystems, and/or a cloud computing system. Analysis apparatus 202 and presentation apparatus 204 may additionally be implemented together and/or separately by one or more hardware and/or software components and/or layers.

Second, the functionality of analysis apparatus 202 and presentation apparatus 204 may be used with other types of content. For example, the analysis apparatus may calculate a ranking score for a title of content item 216 based on the similarity of the title to the remainder of the content item, the inverse frequency weight of the title, and/or other values associated with the title. The ranking score may then be used to include the title in summary 244 or exclude the title from summary 244, in lieu of or in addition to generating the summary from a subset of text units in the content item. In another example, words in the title and/or one or more keywords may be used in the calculation of similarity scores and/or inverse frequency weights for text units in the content item. As a result, a text unit that is more similar to the title and/or keyword(s) may be assigned a higher similarity score than a text unit that is less similar to the title and/or keyword(s).

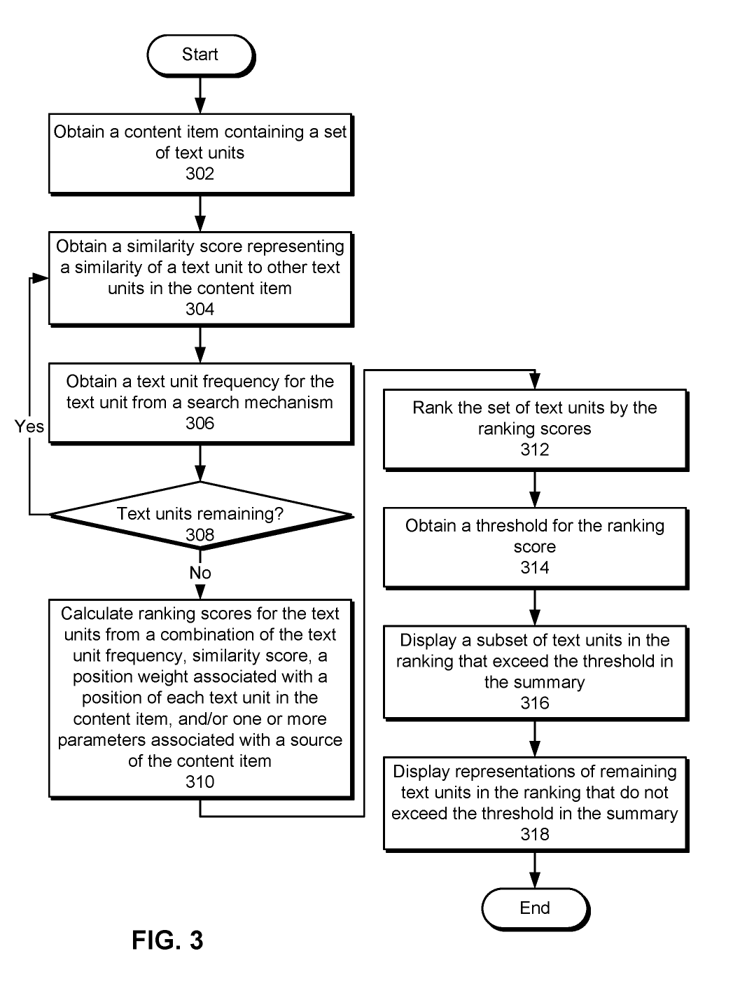

FIG. 3 shows a flowchart illustrating the processing of textual content in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a content item containing a set of text units is obtained (operation 302). For example, the content item may be an article, post, review, complaint, and/or other longer-form textual content. The content item may be separated into sentences, words, n-grams, phrases, and/or other text units. Next, a similarity score representing a similarity of a text unit to other text units in the content item is obtained (operation 304). The similarity score may be calculated by matching words in the text unit to identical words in the other text units and/or synonyms of the words in the other text units. A text unit frequency for the text unit is also obtained from a search mechanism (operation 306). For example, the text unit frequency may be obtained as the number of search results returned by a search engine in response to a query containing the text unit as a search term.

Operations 304-306 may be repeated for remaining text units (operation 308) in the content item. For example, a similarity score and text unit frequency may be obtained for each sentence in the content item.

A ranking score for the text unit is then calculated from a combination of the text unit frequency, similarity score, a position weight associated with a position of the text unit in the content item, and/or one or more parameters associated with a source of the content item (operation 308). For example, the text unit frequency and a total text unit frequency for the set of text units may be used to calculate an inverse text unit frequency for each text unit. The parameters may be adjusted for customer surveys, articles, complaints, reviews, group discussions, social media content, and/or other sources of content. The ranking score may then be produced by scaling the inverse text unit frequency by the parameters, then multiplying the scaled value by the similarity score and position weight.

After the ranking scores are calculated, the text units are ranked by the ranking scores (operation 312). For example, the text units may be ranked in descending order of ranking score. A set of positions of the text units in the ranking may also be determined and outputted according to an ordering of the text units in the content item. In turn, the outputted positions facilitate efficient filtering of the text units by their respective positions in the ranking.

Finally, the ranking is used to display a summary containing a subset of text units in the content item. In particular, a threshold for the ranking score is obtained (operation 314), and the subset of text units in the ranking that exceeds the threshold is displayed in the summary (operation 316). The threshold may be selected and/or adjusted to achieve a level of compression of the content item in the summary. For example, the threshold may be selected to exclude a portion of characters, words, and/or sentences in the content item from the summary. Representations of remaining text units in the ranking that do not exceed the threshold are also displayed in the summary (operation 318). For example, ellipses and/or other symbols may be displayed in the summary, in lieu of sentences in the content item that have been omitted from the summary. To increase understanding of the content item through the summary, a user may click on and/or otherwise interact with the symbols to view the omitted sentences within the summary.

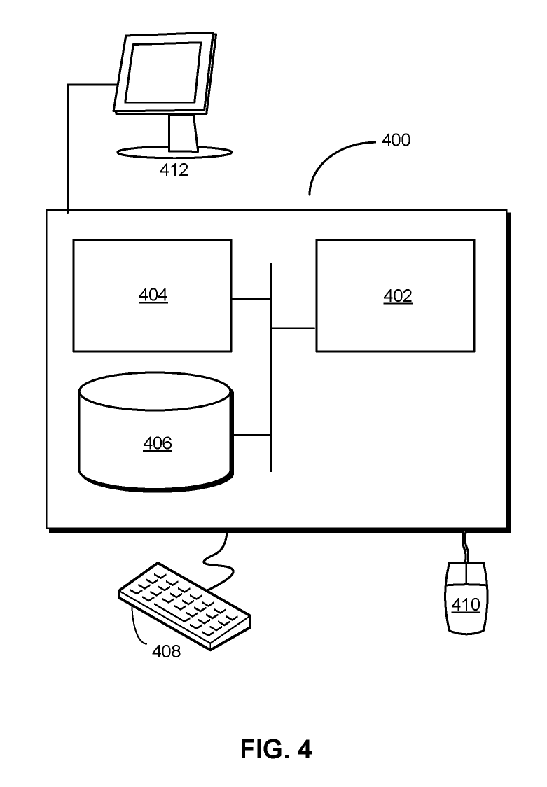

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for processing textual content. The system may include an analysis apparatus and a presentation apparatus, one or both of which may alternatively be termed or implemented as a module, mechanism, or other type of system component. The analysis apparatus may obtain a content item containing a set of text units. For each text unit in the set of text units, the analysis apparatus may obtain a similarity score representing a similarity of the text unit to other text units in the content item and calculate a ranking score for the text unit from a combination that includes a text unit frequency for the text unit, the similarity score, and a position weight associated with a position of the text unit in the content item. The analysis apparatus may then rank the set of text units by the ranking score. Finally, the presentation apparatus may use the ranking to display a summary comprising a subset of the text units in the content item.

In addition, one or more components of computer system 400 may be remotely located and connected to the other components over a network. Portions of the present embodiments (e.g., analysis apparatus, presentation apparatus, content repository, etc.) may also be located on different nodes of a distributed system that implements the embodiments. For example, the present embodiments may be implemented using a cloud computing system that generates and displays summaries of content items to a set of remote members to facilitate analysis and understanding of the content items by the members.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a content item comprising a set of text units;
for each text unit in the set of text units:
obtaining a similarity score representing a similarity of the text unit to other text units in the content item; and
calculating, by a computer system, a ranking score for the text unit from a combination comprising a text unit frequency for the text unit and the similarity score;
ranking the set of text units by the ranking score; and
using the ranking to display a summary comprising a subset of the text units in the content item.

2. The method of claim 1, wherein the combination further comprises a position weight associated with a position of the text unit in the content item.

3. The method of claim 2, wherein the combination further comprises one or more parameters associated with a source of the content item.

4. The method of claim 3, wherein the source is at least one of:
a customer survey;
an article;
a complaint;
a review;
a group discussion; and
social media content.

5. The method of claim 1, wherein calculating the ranking score for the text unit comprises:
obtaining the text unit frequency from a search mechanism;
using the text unit frequency to calculate an inverse text unit frequency weight for the text unit; and
including the inverse text unit frequency weight in the combination.

6. The method of claim 5, wherein the inverse text unit frequency weight is further calculated using a total text unit frequency for the set of text units.

7. The method of claim 1, wherein using the ranking to display the summary comprises:
obtaining a threshold for the ranking score; and
displaying, in the summary, the subset of the text units in the ranking that exceeds the threshold.

8. The method of claim 7, wherein using the ranking to display the summary further comprises:
displaying, in the summary, representations of remaining text units in the ranking that do not exceed the threshold.

9. The method of claim 7, wherein obtaining the threshold for the ranking score comprises:
adjusting the threshold to achieve a level of compression of the content item in the summary.

10. The method of claim 1, wherein ranking the set of text units by the ranking score comprises:
determining a set of positions of the text units in the ranking; and
outputting the positions according to an ordering of the text units in the content item.

11. The method of claim 1, wherein the text unit comprises a sentence.

12. An apparatus, comprising:
one or more processors; and
memory storing instructions that, when executed by the one or more processors, cause the apparatus to:
obtain a content item comprising a set of text units;
for each text unit in the set of text units:
obtain a similarity score representing a similarity of the text unit to other text units in the content item; and
calculate a ranking score for the text unit from a combination comprising a text unit frequency for the text unit and the similarity score;
rank the set of text units by the ranking score; and
use the ranking to display a summary comprising a subset of the text units in the content item.

13. The apparatus of claim 12, wherein the combination further comprises a position weight associated with a position of the text unit in the content item.

14. The apparatus of claim 13, wherein the combination further comprises one or more parameters associated with a source of the content item.

15. The apparatus of claim 12, wherein calculating the ranking score for the text unit comprises:
obtaining the text unit frequency from a search mechanism;
using the text unit frequency and a total text unit frequency for the set of text units to calculate an inverse text unit frequency weight for the text unit; and
including the inverse text unit frequency weight in the combination.

16. The apparatus of claim 12, wherein using the ranking to display the summary comprises:
obtaining a threshold for the ranking score; and
displaying, in the summary, the subset of the text units in the ranking that exceeds the threshold.

17. The apparatus of claim 16, wherein obtaining the threshold for the ranking score comprises:
adjusting the threshold to achieve a level of compression of the content item in the summary.

18. The apparatus of claim 12, wherein ranking the set of text units by the ranking score comprises:
determining a set of positions of the text units in the ranking; and
outputting the positions according to an ordering of the text units in the content item.

19. A system, comprising:
an analysis module comprising a non-transitory computer-readable medium comprising instructions that, when executed, cause the system to:
obtain a content item comprising a set of text units;
for each text unit in the set of text units:
obtain a similarity score representing a similarity of the text unit to other text units in the content item; and
calculate a ranking score for the text unit from a combination comprising a text unit frequency for the text unit and the similarity score; and
rank the set of text units by the ranking score; and
a presentation module comprising a non-transitory computer-readable medium comprising instructions that, when executed, cause the system to use the ranking to display a summary comprising a subset of the text units in the content item.

20. The system of claim 19, wherein using the ranking to display the summary comprises:
obtaining a threshold for the ranking score;
displaying, in the summary, the subset of the text units in the ranking that exceeds the threshold; and
displaying, in the summary, representations of remaining text units in the ranking that do not exceed the threshold.
